(19) United States
(12) Patent Application Publication
(10) Pub. No.: US 2019/0027016 A1
(43) Pub. Date: Jan. 24, 2019

(54) SECURITY SYSTEM AND A METHOD OF USING THE SAME

(71) Applicant: CARRIER CORPORATION, Palm Beach Gardens, FL (US)

(72) Inventor: Penghe Geng, Vernon, CT (US)

(21) Appl. No.: 16/073,002

(22) PCT Filed: Jan. 26, 2017
(86) PCT No.: PCT/US2017/015171

§ 371 Date: Jul. 26, 2018

Related U.S. Application Data
(60) Provisional application No. 62/287,261, filed on Jan. 26, 2016.

(51) Int. Cl. G08B 25/10; G08B 25/00; G08B 25/14

(52) U.S. Cl. CPC G08B 25/10; G08B 25/14; G08B 25/007

(57) ABSTRACT

A security system (10) including a security device (12), the security device including a processor (18), a memory (14) operably coupled to the processor, the memory configured to store a plurality of mobile device identifiers, and a communication device (16) operably coupled to the processor, the communication device configured to transmit and receive communication signals; wherein the processor is configured to operate a program stored in memory, wherein the program is configured to: acquire a mobile device identifier if a communication signal is received for a predetermined duration of time, determine whether the acquired mobile device identifier is one of a plurality of stored mobile device identifiers, and transmit an alarm signal based on the acquired mobile device identifier.

### CROSS REFERENCE TO RELATED APPLICATIONS

The present application is an international patent application, which claims priority to U.S. patent application Ser. No. 62/287,261, filed Jan. 26, 2016, which is herein incorporated in its entirety.

### TECHNICAL FIELD OF THE DISCLOSED EMBODIMENTS

The presently disclosed embodiments generally relate to security systems for buildings, and more particularly to a security system and a method of using the same.

### BACKGROUND OF THE DISCLOSED EMBODIMENTS

For safety and to protect valuable goods, typically, people continue to protect their building (e.g., homes, businesses, farms, etc.) with security systems. One aspect of security systems is an alarm that sounds when an intruder triggers the security system by a sensor sensing an unauthorized opening of a door or window. Some security systems include motion sensors, as well. More advanced security systems include video surveillance. Video surveillance has been used over the years by homeowners to locally record the outside and/or inside of the house. A problem that exists with current security systems is that it requires the system to be armed and a trigger of a sensor to initiate an alarm. It would therefore be appreciated in the art to have a security system that may identify a potential threat before a sensor is triggered and initiate an alarm without a trigger of a sensor.

### SUMMARY OF THE DISCLOSED EMBODIMENTS

In one aspect, a method of operating a security system is provided. The method includes receiving a wireless signal from a mobile device for a pre-determined duration of time, acquiring a mobile device identifier if the security device receives a wireless signal from the mobile device for the pre-determined duration of time; determining whether the acquired mobile device identifier is one of a plurality of stored mobile device identifiers, and transmitting an alarm signal based on the acquired mobile device identifier.

In an embodiment, the mobile device identifier comprises a media access control (MAC) address. In an embodiment, the alarm signal is transmitted to the mobile device. In an embodiment, the alarm signal comprises at least one of an audio signal and a visual signal.

In an embodiment, the pre-determined duration of time comprises approximately 5 minutes. In an embodiment, determining whether the acquired mobile device identifier is one of a plurality of stored mobile device identifiers further includes confirming the acquired mobile device identifier. In one embodiment, determining whether the acquired mobile device identifier is one of a plurality of stored mobile device identifiers further includes determining a signal strength of the wireless signal if the acquired mobile device identifier is not one the plurality of stored mobile device identifiers.

In an embodiment, transmitting an alarm signal based on the acquired mobile device identifier includes transmitting an alarm signal based on the signal strength of the mobile device.

In one aspect, a security system is provided. The security system includes a security device including a processor, a memory operably coupled to the processor, the memory configured to store a plurality of mobile device identifiers, and a communication device operably coupled to the processor, the communication device configured to transmit and receive communication signals. The processor is configured to operate a program stored in memory, wherein the program is configured to acquire a mobile device identifier a communication signal is received for a pre-determined duration of time, determine whether the acquired mobile device identifier is one of a plurality of stored mobile device identifiers, and transmit an alarm signal based on the acquired mobile device identifier.

In an embodiment of the security system, the pre-determined duration of time comprises approximately 5 minutes. In an embodiment of the security system, the mobile device identifier comprises a media access control (MAC) address. In an embodiment of the security system, the alarm signal includes at least one of an audio signal and a visual signal.

In an embodiment of the security system, the program is further configured to confirm the acquired mobile device identifier, and/or determine a signal strength of the received communication signals if the acquired mobile device identifier is not one the plurality of stored mobile device identifiers. In an embodiment of the security system, the program is further to transmit an alarm signal based on the signal strength. In an embodiment of the security system, the alarm signal is transmitted to the mobile device.

In an embodiment, the security system further includes an auxiliary security device in communication with the security device, wherein the auxiliary security device is configured to transmit and receive communication signals.

### BRIEF DESCRIPTION OF DRAWINGS

FIG. 1 illustrates a schematic diagram of a security system according to an embodiment of the present disclosure; and

FIG. 2 illustrates a schematic flow diagram of a method of operating the security system according to an embodiment of the present disclosure.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

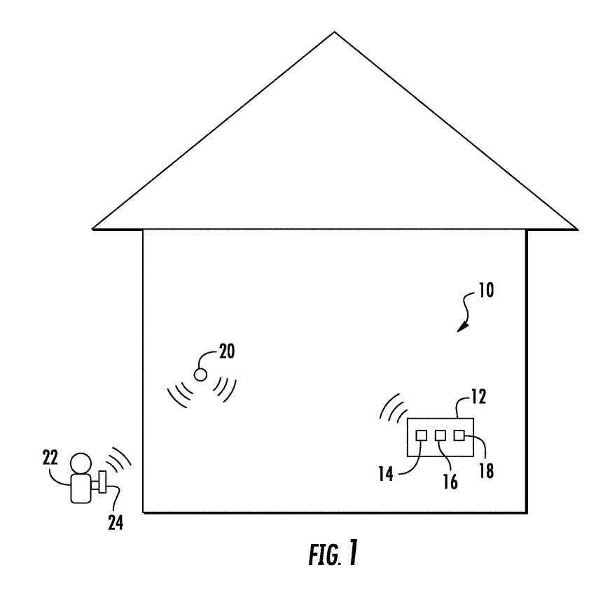

FIG. 1 schematically illustrates an embodiment of a security system, generally indicated at 10. The security system 10 includes a security device 12 including a memory 14 and a communication device 16 operably coupled to a processor 18. In one embodiment, the security device 12 includes a main security panel. It will be appreciated that the security device 12 may also include a display (not shown) to enable the user to interact with the security system 10.

The memory 14 is configured to store a plurality of mobile device identifiers. In an embodiment, each of the plurality of mobile device identifiers includes a media access control (MAC) address. It will be appreciated that the mobile device identifiers may also include a BLUETOOTH address, device brand/manufacturer, and device model number to name a few non-limiting examples. The communication device 16 is configured to transmit and receive communication signals. In one embodiment, the communication signals include wireless communication signals For example, the communication device 16 may be configured to transmit and receive Wi-Fi, BLUETOOTH or other wireless signals to name a couple non-limiting examples. In one embodiment, the communication device 16 is configured to transmit an alarm signal.

The processor 18 is configured to operate in concert with the communication device 16 to acquire a mobile device identifier. The processor 18 is further configured to determine whether the acquired mobile device identifier is one of a plurality of mobile device identifiers stored in memory 14, determine a signal strength of the wireless signal if the acquired mobile device is not one of the plurality of stored mobile device identifiers, and transmit an alarm signal based in part on the acquired mobile device identifier. In an embodiment, the processor 18 is further configured to transmit an alarm signal based on the signal strength of the wireless signal.

In an embodiment, the security system 10 further includes an auxiliary security device 20 in communication with the security device 12. The auxiliary security device 20 includes an auxiliary communication device (not shown) and may be configured to receive and transmit auxiliary communication signals.

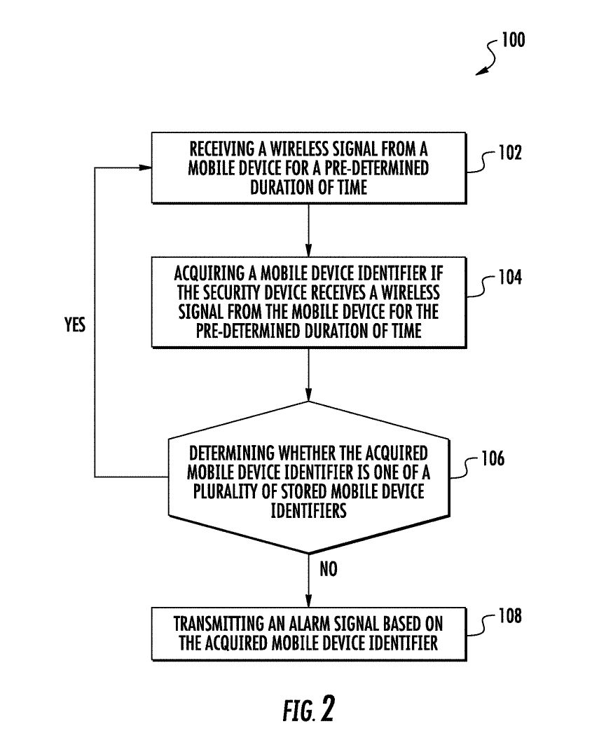

FIG. 2 illustrates a method of operating the security system 10, the method generally indicated at 100. The method 100 includes step 102 of receiving a wireless signal from a mobile device 24 (shown in FIG. 1) for a pre-determined duration of time. In an embodiment, the pre-determined duration of time is approximately 5 minutes. It will be appreciated that the pre-determined duration of time may be greater than or less than approximately 5 minutes. It will further be appreciated that the security system 10 need not be in an armed mode to perform the functions within the method 100.

For example, with reference to FIG. 1, a person 22 may carry a mobile device 24 (for example, a mobile phone, tablet, etc. to name a couple of non-limiting examples) capable of transmitting wireless signals in a vicinity of the security device 12 and/or auxiliary security devices 20. If the person 22 is within the vicinity of the security device 12 and/or auxiliary security devices 20, the mobile device 24 may periodically broadcast a wireless signal in an attempt to connect to the security device 12 enabled by the communication device 16. If the broadcasted wireless signal is received for at least the pre-determined duration of time, it is indicative that the person 22 carrying the mobile device 24 is present for a duration of time that may cause suspicion.

The method 100 further includes step 104 of acquiring a mobile device identifier if the security device 12 and/or auxiliary security devices 20 receive the wireless signal from the mobile device 24 for the pre-determined duration of time. In an embodiment, the mobile device identifier comprises a media access control (MAC) address.

Continuing with the prior example, if it is determined that the mobile device 24 is within range of the security device 12 and/or auxiliary security devices 20 for at least the pre-determined duration of time, the security device 12 operates to acquire a mobile device identifier from the mobile device 24 based on the broadcasted wireless signal from the mobile device 24.

The method 100 further includes step 106 of determining whether the acquired mobile device identifier is one of a plurality of stored mobile device identifiers. In an embodiment, the security device 12 is configured to allow a user to confirm the acquired mobile device identifier.

For example, once the security device 12 acquires the MAC address of the mobile device 24, the processor 18 compares the acquired MAC address to the MAC addresses stored in memory 14. The security device 12, or any other device capable of controlling the security system 10, such as a computer, mobile device of the user, etc. to name a couple of non-limiting examples, may then present a confirmation option to allow the user to accept or reject the acquired mobile device identifier based on whether the person 22 carrying the mobile device 24 is known to the user. If the user confirms the MAC address, it is then stored in memory 14 as a known mobile device 24, and will not need to be confirmed upon subsequent visits. It will be appreciated that the user may deleted store mobile device identifiers within the security device 12, and/or manually enter mobile device identifiers into the security device 12.

In one embodiment, step 106 further includes determining a signal strength of the wireless signal if the acquired mobile device identifier is not one the plurality of stored mobile device identifiers. For example, if the MAC address is not one stored in memory, or rejected by the user, the security device 12 and/or the auxiliary security device 20 may then operate in concert to determine the signal strength of received signals from the mobile device 24 to estimate the distance the mobile phone 22 is from the security device 12 and/or the auxiliary security device 20. The security system 10 may also be used to estimate the position of the mobile device 24 based on triangulation of the wireless signal received by the security device 12 and/or the auxiliary security device 20

The method 100 further includes step 108 of transmitting an alarm signal based on the acquired mobile device identifier. In one embodiment, the alarm signal includes at least one of an audio signal and a visual signal. For example, if the acquired MAC address is determined to be unknown and/or not confirmed, the security device 12 may transmit either or both of an audio signal or visual signal to alert the user that an unknown person is within the vicinity or inside the building.

In another embodiment, the security device 12 may transmit an alarm signal based in part on the acquired mobile device identifier and the signal strength. For example, if the acquired MAC address is determined to be unknown and/or not confirmed, the security device 12 may transmit different alarm signals based on the strength of the signal received from the mobile device 24. For instance, if signal strength is determined to be low by the processor 18, the processor 18 may transmit a low priority alarm signal, such as a flashing yellow light to name one non-limiting examples. On the other hand, if the signal strength is determined to be high by the processor 18, the processor 18 may transmit a high priority alarm signal, such as a flashing red light, and sound an audible buzzer to name a couple of non-limiting examples.

In other embodiments, the visual signal may include a display of a map of the building on the security device 12 or any other authorized device configured to interact with the security system 10. The security device 12 and the auxiliary security devices 20 may track and display the location of the mobile device 24 on the map using a triangulation of the signal strength of the mobile device 24.

In one embodiment, the alarm signal is transmitted to the mobile device 24. For example, the security device 12 may transmit a warning signal to the mobile device 24 warning the possessor of the mobile device 24 that the security system 12 is aware of its presence. It will be appreciated that the alarm signal may also be transmitted to a mobile device of the owner (or authorized person) of the building.

It will therefore be appreciated that the security device 12 may provide more of an advance warning of suspicious activity in the vicinity of a building, even if the security system 10 is not armed, based on whether the person carrying a mobile device 24 has a mobile device identifier known by the security device 12, and may provide different levels of warning based on the mobile device identifier and the signal strength emitted by the mobile device. It will also be appreciated that the security system 10 may also be capable of tracking the mobile device 24 based on the signal strength emitted by the mobile device 24.

While the disclosure has been illustrated and described in detail in the drawings and foregoing description, the same is to be considered as illustrative and not restrictive in character, it being understood that only certain embodiments have been shown and described and that all changes and modifications that come within the spirit of the disclosure are desired to be protected.

What is claimed is:

1. A method of operating a security system, the method comprising:
(a) receiving a wireless signal from a mobile device for a pre-determined duration of time;
(b) acquiring a mobile device identifier if the security device receives a wireless signal from the mobile device for the pre-determined duration of time;
(c) determining whether the acquired mobile device identifier is one of a plurality of stored mobile device identifiers; and
(d) transmitting an alarm signal based on the acquired mobile device identifier.

2. The method of claim 1, wherein the pre-determined duration of time comprises approximately 5 minutes.

3. The method of claim 1, wherein step (c) further comprises confirming the acquired mobile device identifier.

4. The method of claim 1, wherein step (c) further comprises determining a signal strength of the wireless signal if the acquired mobile device identifier is not one the plurality of stored mobile device identifiers.

5. The method of claim 1, wherein the mobile device identifier comprises a media access control (MAC) address.

6. The method of claim 4, wherein step (d) further comprises transmitting an alarm signal based on the signal strength of the mobile device.

7. The method of claim 1, wherein step (d) further comprises transmitting the alarm signal to the mobile device.

8. The method of claim 1, wherein the alarm signal comprises at least one of an audio signal and a visual signal.

9. A security system comprising:
a security device comprising:
a processor;
a memory operably coupled to the processor, the memory configured to store a plurality of mobile device identifiers; and
a communication device operably coupled to the processor, the communication device configured to transmit and receive communication signals;
wherein, the processor is configured to operate a program stored in memory, wherein the program is configured to:
(i) acquire a mobile device identifier a communication signal is received for a pre-determined duration of time;
(ii) determine whether the acquired mobile device identifier is one of a plurality of stored mobile device identifiers; and
(iii) transmit an alarm signal based on the acquired mobile device identifier.

10. The security system of claim 9, wherein the pre-determined duration of time comprises approximately 5 minutes.

11. The security system of claim 9, wherein the program is further configured to confirm the acquired mobile device identifier.

12. The security system of claim 9, wherein the program is further to configured to determine a signal strength of the received communication signals if the acquired mobile device identifier is not one the plurality of stored mobile device identifiers.

13. The security system of claim 9, wherein the mobile device identifier comprises a media access control (MAC) address.

14. The security system of claim 9, wherein the program is further to transmit an alarm signal based on the signal strength.

15. The security system of claim 9, wherein the alarm signal comprises at least one of an audio signal and a visual signal.

16. The security system of claim 9, wherein the alarm signal is transmitted to the mobile device.

17. The security system of claim 9, further comprising an auxiliary security device in communication with the security device, wherein the auxiliary security device is configured to transmit and receive communication signals.
